(19) United States
(12) Patent Application Publication
(10) Pub. No.: US 2017/0329880 A1
(43) Pub. Date: Nov. 16, 2017

(54) SYSTEM & METHOD FOR COMPUTATIONALLY EFFICIENT AND STATISTICALLY ROBUST DESIGN OF MULTI-ARM MULTI-STAGE EXPERIMENTS

(71) Applicant: Cytel Inc., Cambridge, MA (US)

(72) Inventors: Pranab K. Ghosh, Somerville, MA (US); Lingyun Liu, Sharon, MA (US); Pralay Senchaudhuri, Cambridge, MA (US); Cyrus Mehta, Cambridge, MA (US); Ping Gao, Bridgewater, NJ (US); Steve Herbert, Concord, MA (US)

(21) Appl. No.: 15/594,024

(22) Filed: May 12, 2017

Related U.S. Application Data
(60) Provisional application No. 62/336,215, filed on May 13, 2016.

(51) Int. Cl. G06F 17/50; G06F 5/01; G06F 17/18

(52) U.S. Cl. CPC G06F 17/5009; G06F 17/18; G06F 5/01; G06F 2217/16

(57) ABSTRACT

A method and system providing an improved technology for efficiently computing experimental design in strict statistically controlled settings. The method and system utilize a unique combination of statistical algorithms for designing, comparing the performance, and conducting multi-arm, multistage experiments efficiently, while radically reducing the computation time required on a personal computing device, thereby improving computer technology and performance. In particular, the method and system enable personal computing devices to compute very large multi-arm multistage experiments in a significantly reduced period of time. The present invention allows experimentalists to examine in a single statistically controlled experiment a vastly greater range of experimental options, with the possibility of dropping uninformative arms of the experiment, changing goals and parameters during the course of the experiment.

### CROSS-REFERENCE TO RELATED APPLICATION(S)

This application claims priority to, and the benefit of, co-pending U.S. Provisional Application No. 62/336,215, filed May 13, 2016, for all subject matter common to both applications. The disclosure of said provisional application is hereby incorporated by reference in its entirety.

### STATEMENT REGARDING FEDERALLY SPONSORED RESEARCH OR DEVELOPMENT

The government has certain rights in the invention. Research contributing in part to this invention was sponsored in part by National Institutes of Health Grant number HHSN261201200098C. entitled “Statistical Software for Multiple Comparison Procedures”.

### FIELD OF THE INVENTION

The present invention relates generally to experimental design in strict statistically controlled settings and more specifically to a method and apparatus for designing, comparing the performance and conducting multi-arm, multistage experiments efficiently.

### BACKGROUND

In many fields of scientific and commercial study, experiments are conducted to determine the best among many possible choices. The practice of performing such experimentation in a statistically controlled way is known as experimental design. In the medical field, for instance, the term “clinical trial” refers to such tightly controlled experiments.

Modern research and development relies on rapid development and comparative testing of new technologies. This process is slowed and constrained by the high costs of research and development and high failure rates. Comparative testing in a statistically controlled experimental setting has, in the past, predominantly used comparisons of one approach against a control in a single setting. For instance, in a clinical trial this translates to a study comparing the effect of a single therapeutic agent on a single population that is assumed to be homogeneous for a single disease. It has been observed that this approach has been largely unsuccessful for many diseases, such as dementia, stroke, and sepsis, because of the large number of possible outcomes and combinations of tests. For instance, in testing the efficacy of a drug often there are a) existing treatments which must be compared, b) fewer patients in more narrowly focused populations, c) a requirement to employ or test multidrug combinations, d) more side effects to observe, and e) a need to compare multiple arms. If improperly controlled, these situations inflate the inferential errors and considerably complicate maintaining statistical significance of the experiments.

There are large commercial gains across every industry conducting controlled comparative studies, including agriculture, fine chemicals, materials, nanomaterials, engineering, and medicine. The industry of molecular medicine has particularly large commercial gains because drug candidates are specifically targeted to particular genetic profiles and disease etiologies. The expenditures in pharmaceutical research and development in 2016 were estimated to be nearly $14 billion with unimpressive success rates, as measured by the number of new drugs approved which has historically averaged around two dozen for the last several years.

For these reasons there is considerable interest in efficient experimental designs to study multiple test cases in a single experiment while allowing for the possibility of looking at the accruing evidence at stages through the study and stopping certain arms of the experiment early when the experiments show either promising results or results that indicate that the experiments are ineffective. These approaches are commonly known as multi-arm, multistage experimental designs (MAMS designs). Two-arm multi-stage (group sequential) designs have been widely used for over 40 years. The natural generalization of such designs with multiple arms and a common control has, however, been implemented rarely because while the statistical methodology is clear, there has not been an efficient way to perform the computations. Past efforts were hampered by algorithms that are computationally intensive. With the increasing interest in adaptive designs, platform designs and other innovative experimental designs that involve multiple comparisons over multiple stages the importance of MAMS designs is growing rapidly. For instance, in the medical field, the multi-arm trial produces contemporaneous results for all research treatments; this is equally important, for patients and policy makers. Cost and time savings for multi-arm trials versus separate two-arm experiments of 50% have been shown.

Conventional methods implement processes of multiple arm, multiple stage experiments using statistics and algorithms which scale exponentially with the number of arms and stages, and thus are impractical to design, test, and run in the real world where there are often multiple competing hypotheses, and unpredictable outcomes. This situation has created a demand for ways of asking considerably more complex questions in strictly controlled experiments. Conventional systems proposed to tackle such real world situations include complex multi-arm, multistage trials that are limited and rarely run in large-scale commercial settings. This limitation severely restricts research and development relying on data-driven, observational approaches. More specifically, complexity of such conventional systems increases exponentially with number of looks and breaks down entirely for designs with more than 3 looks at the accumulating data. These exponential increases cause these conventional methods to become computationally impractical as the number of comparisons and stages increase. Accordingly, it is impractical to conduct a much larger number of arms and increase the number of interim looks, or stages of the study in the traditional experimental designs in practice.

### SUMMARY

The present invention provides a different technological approach in the form of method and apparatus that combines a novel use of “The Score Statistic” with a unique combination of steps for evaluating the multidimensional integration, radically reducing the computation time required on a personal computer to levels practical for very large multi-arm multistage experiments. Specifically, the present invention is directed to adaptive design techniques for experiments comparing multiple study arms with multiple looks and other studies with multiple different study questions in heterogeneous sample populations using experimental design approaches relying on statistical design and analysis. The complexity (i.e., dimensionality of the multivariate normal integral) of the design of the experiment increases linearly (not exponentially) with both number of stages (looks), J, and number of arms (comparisons), D, in the methodology of the present invention. As such, the increase in complexity of the experiment design as the number of stages and arms increases can be represented as J×D, in accordance with the present invention. Accordingly, the present invention enables experimentalists (including social scientists, data scientists bioinformaticians, engineers, epidemiologists, clinical scientists, food and agricultural researchers, etc.) to examine in a single statistically controlled experiment an unlimited range of experimental options, with the possibility of dropping uninformative arms of the experiment, and changing goals and parameters during the course of the experiment. Prior to the present invention, the number of arms and observations was limited by the extreme computational burden methods. The unique combination of steps provided by the present invention improves prior technology, computer operation, and computer performance in carrying out the required analyses.

In accordance with example embodiments of the present invention, a method of designing multi-arm multistage (MAMS) experiments is provided. The method includes identifying a MAMS experiment problem, breaking the MAMS experiment problem into a plurality of independent increments, each independent increment comprising a multi-stage problem, and reducing a dimensionality of the plurality of independent increments using a Score Statistic. The method also includes transforming the MAMS experiment problem into a finite integration and computing the integration using a quasi-Monte Carlo approach.

In accordance with aspects of the present invention, the method complexity increases linearly based on number of stages and number of arms, as represented by the equation K×D, where K is number of stages and D is number of arms. The method complexity does not increase exponentially based on number of stages and number of arms.

In accordance with aspects of the present invention, breaking the MAMS experiment problem into a plurality of independent increments comprises collecting data from the MAMS experiment, and calculating a cumulative score test statistic. Reducing a dimensionality of the plurality of independent increments using a Score Statistic can include converting the MAMS experiment problem into K consecutive stages.

In accordance with aspects of the present invention, transforming the MAMS experiment problem into a finite integration includes transforming a correlated normal integration into an integration of independent normal variables, transforming a lower integration limits from negative infinity to zero.

In accordance with aspects of the present invention, computing the integration using a quasi-Monte Carlo approach comprises generating lattice points of a lattice, shifting the lattice by a random vector amount, converting to points between zero and one, and evaluating integrand and taking an average. The computations necessary to create multi-arm multistage (MAMS) experiments can be made iteratively to create many designs for a range of design assumptions, such ranges and parameters being input by a user of the system either from an electronic file or manually.

In accordance with example embodiments of the present invention, a system for multistage multi-arm (MAMS) experiments is provided. The system includes a parameter intake, configured to prompt and receive input for experiment design parameters. The system also includes a boundaries intake, configured to prompt and receive input for experiment design boundaries. The system further includes a simulator engine, configured to receive input parameters comprised of the experiment design parameters and the experiment design boundaries, and further configured to execute simulations determining boundaries efficacy based on the input parameters. The simulator engine utilizes a method including breaking a MAMS experiment problem into a plurality of independent increments, each independent increment comprising a three-stage problem, reducing a dimensionality of the plurality of independent increments using a Score Statistic, and transforming the MAMS experiment problem into a finite integration using a quasi-Monte Carlo number theoretic approach, computing the integration.

In accordance with aspects of the present invention, the experiment design parameters comprise acceptable error rates, anticipated difference between arms, estimated variance of outcome, and allocation of sample between arms.

In accordance with aspects of the present invention, the experiment design boundaries comprise select spending function and input spacing of interim looks. Any number of experimental simulations, resulting from applying the mathematics described for claim 1 iteratively, may be compared in a graphic and/or tabular form within the system and favorable designs selected and retained.

In accordance with example embodiments of the present invention, method of designing a multi-arm multistage (MAMS) experiment is provided. The method includes receiving input parameters comprising experiment design parameters and experiment design boundaries, computing boundaries, computing sample size, and executing a first simulation of the MAMS experiment to determine a first set of boundaries efficacy. The method also includes modifying one or more input parameters, executing a second simulation of the MAMS experiment to determine a second set of boundaries efficacy, and comparing the first set of boundaries efficacy with the second set of boundaries efficacy to identify a preferred boundaries efficacy.

In accordance with example embodiments of the present invention, a method for constructing a D-arm J-stage design for N number of stages is provided. The method includes computing a first boundary for a first stage N using a distribution of D-score statistics at the first stage, incrementing a stage value N by one and advancing to a next stage, and updating the distribution of D-score statistics at a second stage for a second stage N+1. The method also includes computing a second boundary for the second stage N+1 using the distribution of D-score statistics at a second stage, incrementing a stage value N+1 by one and advancing to a next stage, and continuing incrementing stage values, advancing stages, and updating the distribution of D-score statistics to correspond to the stage values until a stage value is equal to J number of stages.

### BRIEF DESCRIPTION OF THE FIGURES

These and other characteristics of the present invention will be more fully understood by reference to the following detailed description in conjunction with the attached drawings, in which:

FIGS. 1A and 1B are flow charts depicting a method of operation for the statistical algorithm in accordance with the present invention;

FIG. 2 is a flow chart depicting a method of operation for the system operating the statistical algorithm in accordance with the present invention;

FIG. 3 is an exemplary graphical user interface for use in accordance with the present invention;

FIG. 4 is an exemplary graphical user interface for use in accordance with the present invention;

FIG. 5 is an exemplary graphical user interface for use in accordance with the present invention; and

FIG. 6 is a diagrammatic illustration of a high level architecture for implementing processes in accordance with aspects of the invention.

### DETAILED DESCRIPTION

The present invention provides a technological improvement to computer operation by implementation of novel algorithms that, in combination, can compute the multi-dimensional integrations in MAMS design substantially more rapidly than prior computing processes, thereby making experimental designs with increasing numbers of comparisons and stages practical for the first time. The improvement to the prior technology is at least in part defined by logical structures and processes, which in combination make the computer operation substantially more efficient and faster. The type of performance provided by the present invention frees a trial designer to experiment with different design options including number of looks, types of stopping boundaries and sample size, under alternative scenarios for the treatment effects. This is a crucially important consideration for optimizing trial design. If one had to wait several hours or days in between scenarios it is unlikely that one would consider more than one or two design options and might miss out on the best possible design for the situation under consideration.

To provide an example process for performing statistical experimentation, consider designing a placebo controlled, double blind, and randomized experiment (in this example, a clinical trial) to evaluate the efficacy, pharmacokinetics, safety and tolerability of a new therapy given as multiple weekly infusions in subjects with a recent acute coronary syndrome. In this example, there are four dose regimens to be investigated that equate to four experiment arms, each being compared in pairwise fashion to a common control arm. The treatment effect is assessed through the change in PAV (percent atheroma volume) from baseline to day 36 post-randomization, as determined by IVUS (intravascular ultrasound). Suppose that three stages or looks (e.g., specific to clinical trials) of experimentation are desired for early stopping for overwhelming efficacy. For the purposes of the disclosure, the equations and results discussed herein are specific to utilization for four experiment arms, one common control arm, and three experiment stages. As would be appreciated by one skilled in the art, the below equations and results can be adjusted and operable to compute any combination of experimental arms and experimental stages.

The design mentioned above is a special class of experimental design called multiple arms multiple stages (MAMS). The present invention provides a method for designing, selecting an optimal design, and conducting an experiment having multiple arms and multiple stages. In a general form the present invention includes a specific combination of steps, which when conducted together provide a novel advance on and departure from prior practice. Specifically, the specific combination of steps of the present invention create a computationally friendly and efficient process to perform statistical experimentation regardless of a number of comparisons or stages in the experimentation, particularly in MAMS problems. The first step includes breaking a MAMS problem into many two-stage problems, known as independent increments. The second step includes reducing the dimensionality of the resulting problems by utilizing “The Score Statistic” which is the treatment effect estimate standardized by the variance and is known to have independent increments. The third step includes transforming the problem into a computationally tractable, finite integration. The fourth step includes using a (number theoretic) quasi-Monte Carlo, approach to compute the integration. The fifth step provides a user interface employing the first four steps as the computational engine to simulate multiple scenarios. The sixth step provides a user interface to compare and select the most favorable experimental designs from the various scenarios. The six steps work together to create a computationally tractable solution to designing, testing, selecting, and performing complex multi-arm, multistage experiments with strict statistical control.

A detailed description for each of the six steps, using the example mentioned above is described herein. As would be appreciated by one skilled in the art, these methods are applicable to generic setting with any number of arms or doses and any number of stages or looks and any type of endpoints and is not limited to the number of arms/stages/looks provided in the exemplary embodiments discussed herein. For the purposes of the disclosure, the following example of the six steps is specific to four experiment arms or doses compared to a common control and three experiment stages or looks. As would be appreciated by one skilled in the art, the below equations and results can be adjusted and operable to compute any combination of experimental arms or doses and experimental stages or looks. Additionally, for purposes of the following example, the use of stage is replaced with the term look which is specific terminology to clinical trials. Similarly, the use of the term arm is replaced with the usage of the terminology of doses for purposes of the specific clinical example.

The method of the present invention starts with the first step of breaking a MAMS problem into many two-stage problems, known as independent increments. In particular, to design the experiment summarized above, the method computes the efficacy stopping boundary at each stage or looks at the data so that the overall family-wise error rate is controlled at, for instance, a one-sided significance level of 0.025 (α). To derive the boundary of such a design efficiently, the methods formulate the problem in terms of “The Score Statistics”. \vec{W}ⱼ≡(W₁ⱼ, W₂ⱼ, W₃ⱼ, W₄ⱼ) denotes the cumulative Score Statistics for comparing the four doses to control at look j, where the cumulative score statistic for the ith arm is defined as

Wᵢⱼ=\hat{δ}ᵢⱼIᵢⱼ (1)

Iᵢⱼ=(Var(\hat{δ}ᵢⱼ))⁻¹ denotes the cumulative Fisher's information for the i^{th} dose (where a dose is an experimental arm for the general case) by look j.

\vec{W}₍ⱼ₎≡(W₁₍ⱼ₎, W₂₍ⱼ₎, W₃₍ⱼ₎, W₄₍ⱼ₎) denotes the incremental statistics where the incremental statistic for the ith arm is defined as

Wᵢ₍ⱼ₎=Wᵢⱼ−W_{i,j-1} (2)

The Score Statistic is related to the Wald statistic Zᵢⱼ by the information at look j, i.e. Wᵢⱼ=Zᵢⱼ\sqrt{Iᵢⱼ}. The Score Statistics have independent increments, i.e. \vec{W}₍ⱼ₎ is independent of \vec{W}ⱼ₋₁ and normally distributed with mean \vec{μ}₍ⱼ₎≡(δ₁I₁₍ⱼ₎, δ₂I₂₍ⱼ₎, δ₃I₃₍ⱼ₎, δ₄I₄₍ⱼ₎) and variance (I₁₍ⱼ₎, I₂₍ⱼ₎, I₃₍ⱼ₎, I₄₍ⱼ₎) where δ's are the underlying treatment effects and Iᵢ₍ⱼ₎=Iᵢⱼ−I_{i,j-1} is the incremental information for dose i (where dose is the experimental arm for the general case) at look j. The covariance between Wₖ₍ⱼ₎ and Wₗ₍ⱼ₎ is given by

$$cov ( {W}_{k ( j )} , {W}_{l ( j )} ) = {[ ( \frac{{σ}_{k}^{2}}{{λ}_{k}} + {σ}_{0}^{2} ) ( \frac{{σ}_{l}^{2}}{{λ}_{l}} + {σ}_{0}^{2} ) ]}^{- 1} {σ}_{0}^{2} * {n}_{0 ( j )}$$

where
σ's are the standard deviations, λ's are the allocation ratio to control and n₀₍ⱼ₎ is the incremental sample size for control group at look j. Using the independent increment properties, the present invention derives the conditional distribution of \vec{W}ⱼ \vec{W}ⱼ₋₁ given which is multivariate normal with mean \vec{W}ⱼ₋₁+\vec{μ}₍ⱼ₎ and the covariance that is the same as the variance-covariance matrix for Wᵤ). The efficacy boundary (e.g., the boundary which when crossed, the particular experimental arm or dose will be considered to be successful) is derived recursively for a given error spending approach. The concept of spending error against an error-budget is generally accepted as necessary to maintain the strict statistical control claimed here Suppose that α₁, α₂ and α₃ are the type I error spent at each look such that α₁+α₂+α₃=α. Then the corresponding efficacy boundaries e₁, e₂, e₃ are obtained by solving the following equations when the global null hypothesis is true.

$$\begin{matrix}P ( {max}_{i} \{ {W}_{i 1} \} > {e}_{1} ) = {α}_{1} & ( 3 ) \\ P ( {max}_{i} \{ {W}_{i 1} \} < {e}_{1} ⋂ {max}_{i} \{ {W}_{i 2} \} > {e}_{2} ) = {α}_{2} & ( 4 ) \\ P ( {max}_{i} \{ {W}_{i 1} \} < {e}_{1} ⋂ {max}_{i} \{ {W}_{i 2} \} < {e}_{2} ⋂ {max}_{i} \{ {W}_{i 3} \} > {e}_{3} ) = {α}_{3} & ( 5 )\end{matrix}$$

At the first look, the boundary e₁ is derived by solving the following integration:

∫_{-∞}^{e}^{₁}∫_{-∞}^{e}^{₁}∫_{-∞}^{e}^{₁}∫_{-∞}^{e}^{₁}p(\vec{w}₁)d\vec{w}₁=1−α₁ (6)

The boundary e₂ at the second look satisfies equation (4) which is equivalent to:

$$P ( {max}_{i} \{ {W}_{i 1} \} < {e}_{1} ⋂ {max}_{i} \{ {W}_{i 2} \} < {e}_{2} ) = 1 - {α}_{1} - {α}_{2} \qquad ( 7 )$$

Therefore the boundary e₂ at look two is obtained by solving the following equation:

$$\begin{matrix}{{∮}^{{e}_{1}}}_{- ∞} {{∮}^{{e}_{2}}}_{- ∞} p ( {\vec{w}}_{1} , {\vec{w}}_{2} ) d {\vec{w}}_{1} d {\vec{w}}_{2} = 1 - {α}_{1} - {α}_{2} & ( 8 ) \\ {{∮}^{{e}_{1}}}_{- ∞} {{∮}^{{e}_{2}}}_{- ∞} p ( {\vec{w}}_{2} \vert {\vec{w}}_{1} ) p ( {\vec{w}}_{1} ) d {\vec{w}}_{2} d {\vec{w}}_{1} = 1 - {α}_{1} - {α}_{2} & \\ {{∮}^{{e}_{1}}}_{- ∞} {{∮}^{{e}_{2} - {\vec{w}}_{1}}}_{- ∞} p ( {\vec{w}}_{2} - {\vec{w}}_{1} \vert {\vec{w}}_{1} ) p ( {\vec{w}}_{1} ) d {\vec{w}}_{2} d {\vec{w}}_{1} = 1 - {α}_{1} - {α}_{2} & \\ {{∮}^{{e}_{1}}}_{- ∞} {{∮}^{{e}_{2} - {\vec{w}}_{1}}}_{- ∞} p ( {\vec{w}}_{( 2 )} ) p ( {\vec{w}}_{1} ) d {\vec{w}}_{( 2 )} d {\vec{w}}_{1} = 1 - {α}_{1} - {α}_{2} & \end{matrix}$$

The boundary e₃ at the third look satisfies equation (5) which is equivalent to:

$$P ( {max}_{i} \{ {W}_{i 1} \} < {e}_{1} ⋂ {max}_{i} \{ {W}_{i 2} \} < {e}_{2} ⋂ {max}_{i} \{ {W}_{i 3} \} < {e}_{3} ) = 1 - {α}_{1} - {α}_{2} - {α}_{3} \qquad ( 9 )$$

Using the same approach as second look, e₃ is found by solving the following integration:

$${{∮}^{{e}_{1}}}_{- ∞} {{∮}^{{e}_{2} - {\vec{w}}_{1}}}_{- ∞} {{∮}^{{e}_{3} - {\vec{w}}_{2}}}_{- ∞} p ( {\vec{w}}_{( 3 )} ) p ( {\vec{w}}_{( 2 )} ) p ( {\vec{w}}_{1} ) d {\vec{w}}_{( 3 )} d {\vec{w}}_{( 2 )} d {\vec{w}}_{1} = 1 - {α}_{1} - {α}_{2} - {α}_{3} \qquad ( 10 )$$

The method of the present invention continues with the second step of reducing the dimensionality of the resulting problem by utilizing “The Score Statistic”. Due to the independent increment of “The Score Statistics”, computing probability at a look depends only on the previous look. Therefore, the dimensionality of the multidimensional integral for computing this multivariate normal probability is limited to three consecutive looks. For example, the computation at look three is essentially reduced to evaluation of p(\vec{w}₍₃₎) which is independent of \vec{w}₍₁₎ and \vec{w}₍₂₎.

The boundary computation involves a searching algorithm using bisection method, which iteratively evaluates the integrals in equations (6), (8), and (10). A numerical integration method is used to compute the integral for each iteration. Numerical integration methods compute integration by combining evaluations of the integrand to get an approximation to the integral, this property is exploited in the present invention. The integrand is evaluated at a finite set of points called integration points and a weighted sum of these values is used to approximate the integral. Evaluation of the integrand is the most time consuming task during the numerical integration. This present invention reduces the computational intensity by taking advantage of independent increment properties with “The Score Statistics”. For example, the method of the present invention stores the values of p(\vec{w}₁) computed at all the integration points for \vec{w}₁ at the first look and reuses them at the second look. At the second look, the conditional density p(\vec{w}₂|\vec{w}₁) at all the integration points of \vec{w}₂ is computed for any integration point of \vec{w}₁.

The method of the present invention continues with the third step of transforming the problem into a computationally tractable, finite integration. Each experiment stage is represented by an observation of the data, a “look”, to see if the data point(s) cross a decision boundary which defines that experimental arm as futile, efficacious, dangerous (harmful in the clinical setting) or promising. These decision boundaries are commonly called “group sequential boundaries.” To compute the group sequential boundaries, the present invention solves the equations (6), (8), and (10). All the integrations have lower limits of −∞. The present invention utilizes proper Gaussian integration transformation to get finite integration ranges. Integrand functions in equation (6) follow normal distribution with mean vector \vec{0} and variance n₀₁Σ, where:

$${\sum }_{kl} = \{ \begin{matrix}{[ ( \frac{{σ}_{k}^{2}}{{λ}_{k}} + {σ}_{0}^{2} ) ( \frac{{σ}_{l}^{2}}{{λ}_{l}} + {σ}_{0}^{2} ) ]}^{- 1} {σ}_{0}^{2} , & k \neq l \\ {[ ( \frac{{σ}_{k}^{2}}{{λ}_{k}} + {σ}_{0}^{2} ) ]}^{- 1} , & k = l\end{matrix}$$

Let Σ=CC^{t} be the Cholesky decomposition of the Σ matrix, where C is a lower triangular matrix. Using the transformation \vec{w}₁=\sqrt{n₀₁}C\vec{u}₁, equation (6) becomes:

∫_{-∞}^{b}^{₁₁}φ(u₁₁)∫_{-∞}^{b}^{₂₁}φ(u₂₁)∫_{-∞}^{b}^{₃₁}φ(u₃₁)∫_{-∞}^{b}^{₄₁}φ(u₄₁)d\vec{u}₁=1−α₁ (10a)

where

$${b}_{i 1} = \frac{1}{{c}_{ii}} ( \frac{1}{\sqrt{{n}_{01}}} {e}_{1} - {\sum }_{j = 1}^{i - 1} {c}_{ij} {u}_{j 1} ) ,$$

φ is the standard normal density function and Φ is the standard normal distribution function.

Next the present invention utilizes the transformation Φ(uᵢ₁)=zᵢ₁ and derives:

$${\int }_{0}^{{d}_{11}} {\int }_{0}^{{d}_{21}} {\int }_{0}^{{d}_{31}} {\int }_{0}^{{d}_{41}} d {\vec{z}}_{1} = 1 - {α}_{1} \\ where \\ {d}_{i 1} = {Φ}^{- 1} ( \frac{1}{{c}_{ii}} ( \frac{1}{\sqrt{{n}_{01}}} {e}_{1} - {\sum }_{j = 1}^{i - 1} {c}_{ij} {Φ}^{- 1} ( {z}_{j 1} ) ) ) . \qquad ( 10 b )$$

Final transformation will be used to convert the integration range to [0, 1] cube. Using zᵢ₁=dᵢ₁xᵢ₁ for all i=1, 2, 3, 4 the present invention derives:

$$\begin{matrix}{\int }_{0}^{1} {d}_{11} {\int }_{0}^{1} {d}_{21} {\int }_{0}^{1} {d}_{31} {\int }_{0}^{1} {d}_{41} d {\vec{x}}_{1} = 1 - {α}_{1} & ( 11 ) \\ where & \\ {d}_{i 1} = {Φ}^{- 1} ( \frac{1}{{c}_{ii}} ( \frac{1}{\sqrt{{n}_{01}}} {e}_{1} - {\sum }_{j = 1}^{i - 1} {c}_{ij} {Φ}^{- 1} ( {d}_{j 1} {x}_{j 1} ) ) ) & ( 12 )\end{matrix}$$

To compute the boundary e₁ the present invention solves the previous equation. Next, the present invention solves equation (8). In equation (8) \vec{w}₍₂₎ also follows normal distribution with mean 0 and covariance matrix n₀₍₂₎Σ. Similar to the second look, the present invention utilizes the first transformation \vec{w}₁=\sqrt{n₀₁}C\vec{u}₁, \vec{w}₂=\sqrt{n₀₍₂₎}C\vec{u}₍₂₎. Then the integration becomes:

∫_{-∞}^{b}^{₁₁}φ(u₁₁) . . . ∫_{-∞}^{b}^{₄₁}φ(u₄₁)∫_{-∞}^{b}^{₁₂}φ(u₁₂) . . . ∫_{-∞}^{b}^{₄₂}φ(u₄₂)d\vec{u}₂d\vec{u}₁=1−α₁−α₂

Here b₁₁ the same formula is represented as the first look:

$${b}_{i 2} = \frac{1}{{c}_{ii}} [ \frac{1}{\sqrt{{n}_{0 ( 2 )}}} ( {e}_{2} - {\sum }_{j = 1}^{i} {c}_{ij} {u}_{j 1} ) - {\sum }_{j = 1}^{i - 1} {c}_{ij} {u}_{j 2} ]$$

As in the first look, the transformation Φ(uᵢ₁)=zᵢ₁ and Φ(uᵢ₂)=zᵢ₂ are used. This transforms the boundary formula for the second look as:

∫₀^{d}^{₁₁} . . . ∫₀^{d}^{₄₁}∫₀^{d}^{₁₂} . . . ∫₀^{d}^{₄₂}d\vec{z}₁d\vec{z}₂=1−α₁−α₂

Here dᵢ₁'s are the same as the first look:

$${d}_{i 2} = {Φ}^{- 1} ( \frac{1}{{c}_{ii}} ( \frac{1}{\sqrt{{n}_{0 ( 2 )}}} ( {e}_{2} - \sqrt{{n}_{01}} {\sum }_{j = 1}^{i} {c}_{ij} {Φ}^{- 1} ( {z}_{j 1} ) ) - {\sum }_{j = 1}^{i - 1} {c}_{ij} {Φ}^{- 1} ( {z}_{j 2} ) ) )$$

The final transformation converts the integral range of each variable between 0 and 1. For the final transformation, the present invention utilizes the transformation zᵢ₁ dᵢ₁xᵢ₁ and zᵢ₂=dᵢ₂xᵢ₂. Using this transformation equation (8) becomes:

∫₀¹d₁₁ . . . ∫₀¹d₄₁∫₀¹d₁₂ . . . ∫₀¹d₄₂d\vec{x}₂d\vec{x}₁=1−α₁−α₂ (13)

where dᵢ₁'s can be obtained from equation (12) and dᵢ₂'s are given below:

$${d}_{i 2} = {Φ}^{- 1} ( \frac{1}{{c}_{ii}} ( \frac{1}{\sqrt{{n}_{0 ( 2 )}}} ( {e}_{2} - \sqrt{{n}_{01}} {\sum }_{j = 1}^{i} {c}_{ij} {Φ}^{- 1} ( {d}_{j 1} {x}_{j 1} ) ) - {\sum }_{j = 1}^{i - 1} {c}_{ij} {Φ}^{- 1} ( {d}_{j 2} {x}_{j 2} ) ) ) \qquad ( 14 )$$

Using a similar type of transformations the present invention can convert equation (10) to the following form:

∫₀¹d₁₁ . . . ∫₀¹d₄₁∫₀¹d₁₂ . . . ∫₀¹d₄₂∫₀¹d₁₃ . . . ∫₀¹d₄₃d\vec{x}₃d\vec{x}₂d\vec{x}₁=1−α₁−α₂−α₃ (15)

where dᵢ₁'s, dᵢ₂'s are the same as in equations (12), (14) and dᵢ₃'s are:

$${d}_{i 3} = {Φ}^{- 1} ( \frac{1}{{c}_{ii}} ( \frac{1}{\sqrt{{n}_{0 ( 3 )}}} ( {e}_{2} - {\sum }_{j = 1}^{i} {c}_{ij} ( \sqrt{{n}_{01}} {Φ}^{- 1} ( {d}_{j 1} {x}_{j 1} ) + \sqrt{{n}_{0 ( 2 )}} {Φ}^{- 1} ( {d}_{j 2} {x}_{j 2} ) ) ) - {\sum }_{j = 1}^{i - 1} {c}_{ij} {Φ}^{- 1} ( {d}_{j 3} {x}_{j 3} ) ) ) \qquad ( 16 )$$

The method of the present invention continues with the fourth step of computing the integration using a Quasi Monte Carlo, or number theoretic, approach. As would be appreciated by one skilled in the art, one can use any numerical integration formula to evaluate the integrations in equations (11), (13), and (15). In accordance with an example embodiment of the present invention, the present invention will utilize a Monte Carlo method to evaluate these integrals. To evaluate integration the present invention selects random vectors of \vec{x}₁ from the range of (0,1)⁴ then evaluates the integrand to take average of them as a value of the integrand. When the present invention solves the equation (11) the present invention stores the values of (d₁₁, d₂₁, d₃₁, d₄₁) and (Φ⁻¹(d₁₁x₁₁), . . . , Φ⁻¹(d₄₁x₄₁)) for each randomly chosen \vec{x}₁. The stored values are utilized for evaluating the integral in equation (13) and the values of dᵢ₂'s in equation (15). When the present invention evaluates equation (13), the present invention utilizes the same \vec{x}₁ points and selects another random set of \vec{x}₂. Thereafter, the present invention stores the values of \vec{d}₂ vector and (Φ⁻¹(d₁₂x₁₂), . . . , Φ⁻¹(d₄₂x₄₂)). These are utilized by the present invention for computing the integral in equation (15) and evaluating values of dᵢ₃'s in equation (16). But instead of using crude Monte Carlo method the present invention utilizes the quasi-Monte Carlo to evaluate these integrals.

In particular, utilizing the (number theoretic) quasi-Monte Carlo approach to compute the integration. For example, the following integral is evaluated:

I=∫₀¹ . . . ∫₀¹f(\vec{x})d\vec{x}

Utilizing the Crude Monte Carlo method would evaluate this integral as:

$${I}_{N} = {\sum }_{i = 1}^{N} f ( {\vec{x}}_{i} )$$

for \vec{x}ᵢ's being sampled from n dimensional unit cube. As a consequence of The Law of Large Numbers (Jakob Bernoulli, 1713).

$${lim}_{N \to ∞} {I}_{N} = I$$

I_{N} works as an estimator of I.

As would be appreciated by one skilled in the art, due to the Central Limit Theorem (e.g., as provided by Abraham de Moivre c1730), the error bound of estimating I by I_{N} can be estimated by the variance of I_{N}, which is

$$\frac{{σ}^{2}}{N}$$

(σ² being the variance off). A standard way of variance reduction is to use of antithetic variates suggests replacing f(xᵢ) by

$$\frac{f ( {x}_{i} ) + f ( 1 - {x}_{i} )}{2} .$$

In general there are two approaches that one can use to reduce the error in the Monte Carlo method. One is by variance reduction and another one is by replacing independent random choice of points x, by an alternate or fixed sequence. As discussed herein, the probabilistic error bound of crude Monte Carlo method is of order \sqrt{N}. This approach will improve the −½ component. Quasi Monte Carlo (QMC) method (also known as number theoretic method) uses fixed sequence of sample points \vec{x}ᵢ. These points are uniformly scattered over unit cubes are also called a low-discrepancy set of points. Three important classes of low-discrepancy sets are available now and they are Kronecker sequence (e.g., as provided by Leopold Kronecker, 1882), Lattices and digital sets. For the current problem, the present invention utilizes only the lattice rules. A rank-1 is a set of N points are of following form:

$${L}_{N} = \{ \frac{i \vec{v}}{N} mod 1 ; i = 1 , 2 , … , N \}$$

where \vec{v} is n dimensional integer vector that depends on N.

One common choice for \vec{v} (e.g., as provided by Korobov, N. M.) is:

\vec{v}=(1,h,h² mod N, . . . ,hⁿ⁻¹ mod N) (17)

$$1 \leq h \leq ⌊ \frac{N}{2} ⌋ ( ⌊ a ⌋$$

for some integer h satisfying denotes the largest integer smaller than a) and a prime N.

One big problem for any Quasi Monte Carlo integration is that there is no similar method available to compute the error bounds. Therefore, the present invention utilizes a randomized lattice rule, which will give an unbiased estimate of the integration along with a standard Monte Carlo error estimate. To get the randomized lattice the present invention shifts the whole lattice L_{N} by some Δ˜[0,1]ⁿ for:

L_{N}^{shift}={\vec{x}+Δ mod 1;\vec{x}εL_{N}} (18)

The present invention utilizes the following integration rule of:

$$\begin{matrix}{I}_{M} = \frac{1}{M} {\sum }_{i = 1}^{M} {I}_{N , i} \\ with \text{:} & \\ {I}_{N , i} = \frac{1}{2 N} {\sum }_{j = 1}^{N} ( f ( \vert 2 \{ {\vec{x}}_{j} + {Δ}_{i} ) - 1 \vert ) + f ( 1 - \vert 2 \{ {\vec{x}}_{j} + {Δ}_{i} \} - 1 \vert ) ) & ( 19 )\end{matrix}$$

where {a}=a mod 1 and \vec{x}ⱼ being a point of the lattice. The standard error of I_{M}

$${σ}_{M} = {( \frac{1}{M ( M - 1 )} {\sum }_{i = 1}^{M} {( {I}_{N , i} - {I}_{M} )}^{2} )}^{0.5}$$

This provides an error estimate for I_{M}. The number M should be large enough so that σ_{M} becomes small. The present invention utilizes a two iteration algorithm in Quasi Monte Carlo. The present invention evaluates the equation (19) for one set of lattice points (e.g., one combination of (\vec{v}, N)). The algorithm of the present invention utilizes more than one combination of (\vec{v}, N). For using k such combination, then the final integration value will be:

$${\hat{I}}_{k} = ( {\sum }_{M = 1}^{k} \frac{{I}_{M}}{{σ}_{M}^{2}} ) / \frac{1}{{\overline{σ}}_{k}^{2}}$$

$$and$$

$${\overline{σ}}_{k}^{2} = {( {\sum }_{M = 1}^{k} \frac{1}{{σ}_{M}^{2}} )}^{- 1}$$

The method of the present invention continues with the fifth step which provides a way of iteratively calculating the above four steps to create multiple designs. Thereafter, the method of the present invention continues with the sixth step which provides a way of storing and comparing multiple experimental design scenarios within the system to allow the most favorable design to be selected resulting in the economic benefits of simulation.

Combining the six steps described above, a novel approach has been invented to advance the current practice in design of experiment. In particular, the present invention provides an unconventional combination of steps to solve an issue that was not previously performable, with or without a computer (e.g., significantly reducing computing time for statistical experimentation utilizing multiple comparisons and multiple stages). For example, to design a study, consisting of four arms compared in pairwise fashion to a common control and three stages or looks, the traditional methods and systems would require more than eight hours to compute a type I error rate, power, and sample size. With the novel approach of the present invention, the same computations take less than a minute to compute. Consequently, the innovative of the present invention allows practitioners to design more efficient experiments in a realistic time frame and further facilitates comprehensive evaluations of different design options including adaptively dropping ineffective/unsafe arms and sample size re-estimation.

In a specific comparison, a recent method for generating stopping boundaries and computing sample size for MAMS was created by Magirr, Jacki and Whitehead (2012) (hereafter referred to as “MJW”). This MJW method computes all the probabilities based on the Wald statistics instead of the Score statistics. Table 1 compares the execution times of the combination of steps that make up the algorithm of the present invention, as described herein (hereafter referred to as “NEW”). In particular, Table 1 compares the execution time for a range of treatment comparisons and looks at the accruing data, as computed on the same computing device.

TABLE 1

| | | |
|---|---|---|
| Looks | Comparisons | Execution Times (secs) |

| (J) | (D) | NEW | MJW |
|---|---|---|---|
| 2 | 2 | 1 | 2 |
| | 3 | 1 | 2 |
| | 4 | 2 | 2 |
| | 5 | 2 | 2 |
| 3 | 2 | 1 | 138 |
| | 3 | 1 | 148 |
| | 4 | 1 | 148 |
| | 5 | 2 | 158 |
| 4 | 2 | 1 | >28,800 |
| | 3 | 1 | >28,800 |
| | 4 | 2 | >28,800 |
| | 5 | 2 | >28,800 |
| 5 | 2 | 1 | >28,800 |
| | 3 | 2 | >28,800 |
| | 4 | 2 | >28,800 |
| | 5 | 2 | >28,800 |

Total Sample Size is 600 for all Designs

As reflected by the data provided in TABLE 1, the computing times of NEW algorithm are linear in both number of stages (J) and number of arms (D). In contrast the execution times of the MJW algorithm increase exponentially with J and break down entirely for J>3. It is insightful to analyze why MJW, unlike NEW, is computationally explosive as the number of stages increase. Consider a general MAMS design with J stages and D active arms. Both algorithms must compute the probability of the very same event for a normally distributed statistic Tᵢⱼ and suitably standardized efficacy boundaries uⱼ.

$$R ( \underline{δ} ) = {{⋂}_{i = 1}}^{D} ( {{⋃}^{J}}_{j = 1} [ \{ {{⋂}^{j - 1}}_{i = 1} {T}_{ij} < {u}_{j} \} ] ) \qquad ( 20 )$$

A key difference is that the MJW algorithm uses the Wald statistic \vec{δ}ᵢ\sqrt{Iᵢⱼ} for Tᵢⱼ, whereas the NEW algorithm uses the score statistic δᵢIᵢⱼ for Tᵢⱼ, computing the probability of the event (20). This initial choice of test statistic dooms the MJW algorithm for it can no longer utilize the underlying stage-wise independent increments structure of the problem. Instead the problem is transformed into the form where, for the ith treatment comparison, Φⱼ{Uᵢⱼ} denotes the result of integrating the j-dimensional multivariate normal density over a region defined by a vector of upper limits Uᵢⱼ.

$${\int }_{- ∞}^{∞} … {\int }_{- ∞}^{∞} {\prod }_{i = 1}^{D} [ {\sum }_{j = 1}^{J} {Φ}_{j} \{ {\underline{U}}_{ij} \} ] d Φ ( {t}_{1} ) … d Φ ( {t}_{J} ) \qquad ( 21 )$$

Decomposition of equation (21) into a product of univariate normal integrals such as is obtained in (15) is clearly impossible. Evaluation of (21) is by numerical quadrature. For example, suppose each of the J dimensions of the outer integral ∫_{-∞}^{∞} . . . ∫_{-∞}^{∞}( . . . )dΦ(t₁) . . . dΦ(t_{J}) is divided into G grid points. For each grid point the inner product-sum Πᵢ₌₁^{D}└Σⱼ₌₁^{J}Φⱼ{Uᵢⱼ}┘ is evaluated by repeated calls to a function such as mvtnorm (e.g., as provided by Genz et al. (2016)). For each i=1, 2, . . . D, there are j, repeated calls to mvtnorm, in which each call evaluates a region {−∞, Uᵢⱼ} of a j-dimensional multivariate normal density. This computation must be repeated for j=1, 2, . . . J. It follows that the MJW algorithm must make Σⱼ₌₁^{J}G^{D×j} calls to mvtnorm to evaluate (18). Assuming that G=20, the current implementation of the MJW algorithm in R, one can see why the problem breaks down entirely for J>3, even for the balanced case where only Σⱼ₌₁^{J}G^{j} calls to mvtnorm are needed.

In contrast, the NEW algorithm, by exploiting the independent increments structure of Wᵢⱼ, is able to transform the problem into a simple product of univariate integrals of the form (15) from which the stopping boundaries, type-1 error or power can be obtained by a recursive computation that is linear in D or J when only efficacy boundaries are evaluated, and linear in D but increasing like 2^{J} when both efficacy and futility boundaries are evaluated.

Similarly, prior to the MJW algorithm, numerous other methods have been developed to obtain group sequential boundaries for MAMS designs. Some examples of these methods are Hughes (1993), Follman, Proschan and Geller (1994), Stallard and Todd (2003) and Chen, DeMets and Lan (2010). All these methods utilized the Wald statistic for the computations and so suffer from the same limitation as the MJW algorithm. Hughes (1993) simply utilizes the boundaries of a two-arm clinical trial, relying on binding futility rules established via simulation, for dropping non-performing arms in mid-course, and thereby preserving the type-1 error conservatively. There is no guarantee that this approach will provide strong control of type-1 error. Follman et. al. (1994) start out by computing Bonferroni based stopping boundaries and then adjusting them by simulation. This approach is satisfactory for pre-computing and tabulating stopping boundaries for specific a values, number of arms and number of looks. It may not be as satisfactory when boundaries have to be re-computed via α-spending at interim analyses that do not adhere to the pre-specified design parameters. Stallard and Todd (2003) propose to select the dose with the maximum Wald statistic at the first interim analysis and drop the other doses, so that the remainder of the trial utilizes conventional two-arm boundaries. The option to carry more than one dose forward is not provided. Chen et. al. (2010) utilize numerical quadrature when J×D≦6 and recommend simulation when J×D is more than 6.

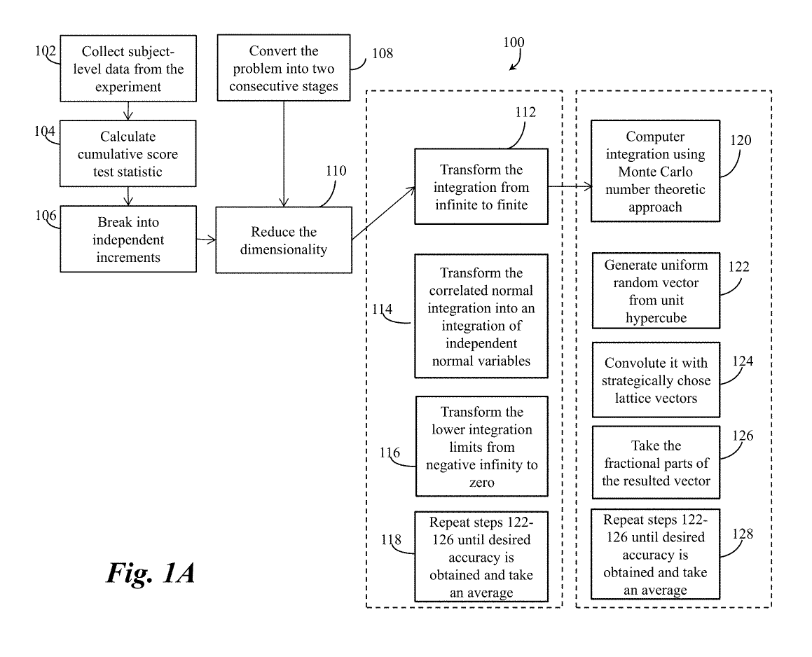

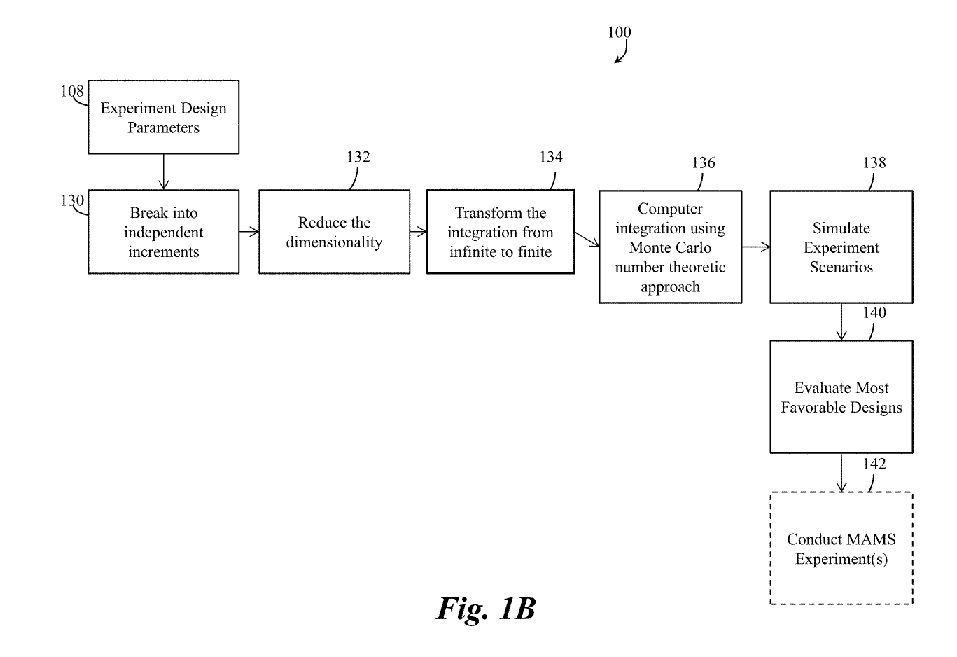

FIGS. 1A through 6, wherein like parts are designated by like reference numerals throughout, illustrate an example embodiment or embodiments of processing of the statistical algorithm, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

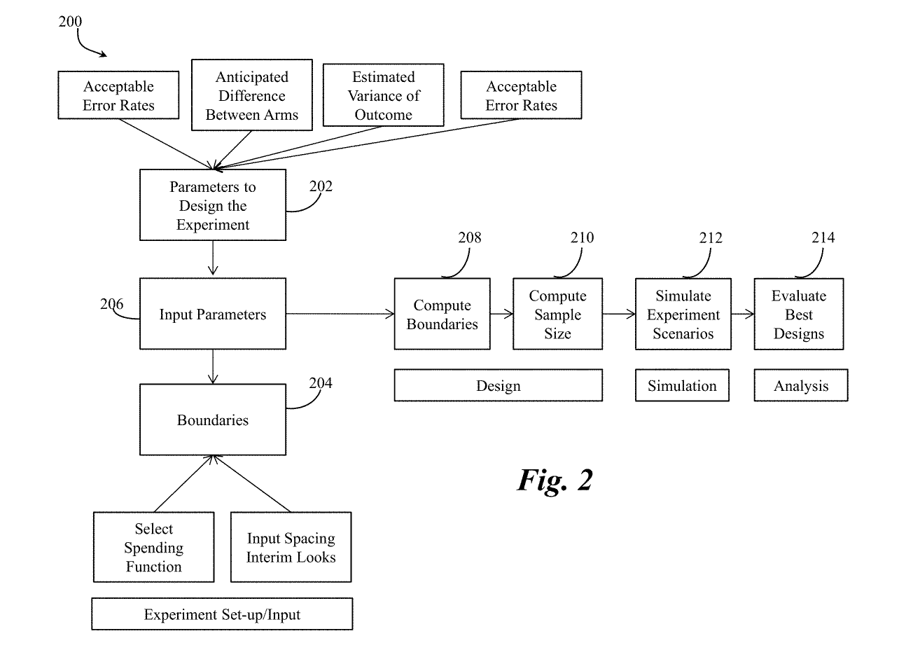

FIGS. 1A, 1B, and 2 show exemplary flow charts depicting implementation of the present invention. Specifically, FIGS. 1A and 1B depict exemplary flow charts showing the operation of a system executing the process 100 of the present invention. In particular, FIG. 1A depicts system (e.g., a universal computing device) executing the process 100 to carry out the novel combination of equations of the present invention, as discussed herein. At step 102, the system collects data (e.g., each of the individual data points) from the experiment. As would be appreciated by one skilled in the art, the data can be collected through manually entry by a user (e.g., via a graphical user interface (GUI)) or automatically obtained from a storage device (e.g., read from a database, files, tables, remotely gathered from the internet, mobile technology or input from a measuring instrument, sensor or measuring apparatus employed in the experiment, etc.).

At step 104, the system calculates cumulative score test statistics. For example the system calculates the cumulative score test statistics utilizing the equations (1). At step 106, the system breaks the cumulative score test statistics into independent increments and advances to step 110. For example the system breaks the cumulative score test statistics into independent increments utilizing the equations (2). At step 108, the system converts the problem into three consecutive stages and advances to step 110. For example the system converts the problem into three consecutive stages utilizing the equations (8), (9), and (10). At step 110, the system utilizes data from steps 106 and 108 and reduces the dimensionality. For example, the system reduces the dimensionality utilizing the equations (8), (9), and (10).

At step 112, the system transforms the integration from infinite to finite. In particular, the system transforms the integration from infinite to finite by executing steps 114-118. At step 114, the system transforms the correlated normal integration into an integration of independent normal variables. For example the system transforms the correlated normal integration into an integration of independent normal variables utilizing the equations (10a). At step 116, the system transforms the lower integrations limits from −∞ to 0. For example the system transforms the lower integrations limits from −∞ to 0 utilizing the equations (10b). At step 118, the system transforms the upper integration limits to 0. For example the system transforms the upper integration limits to 1 utilizing the equations (11). The resultant of steps 114-118 are passed on to step 120 for additional computation.

At step 120, the system computes integration using Monte Carlo approach or number theoretic approach. In particular, the system computes the integration by executing steps 122-128. At step 122, the system generates uniform random vector from unit hypercube. At step 124, the system convolutes the result of step 122 with strategically chosen lattice vectors (e.g., as proposed by Korobov). For example the system generates these lattice points using equation (17). Then at step 126 the system computes the fractional parts of the resulting vectors to evaluate the integrand of the present invention. For example, the system converts the points between 0 and 1 utilizing the equations (18). At step 128, the system repeats steps 122-126 until a desired level of accuracy is obtained and takes an average as an integration output. For example, the system evaluates the integrand and takes an average utilizing the equations (19).

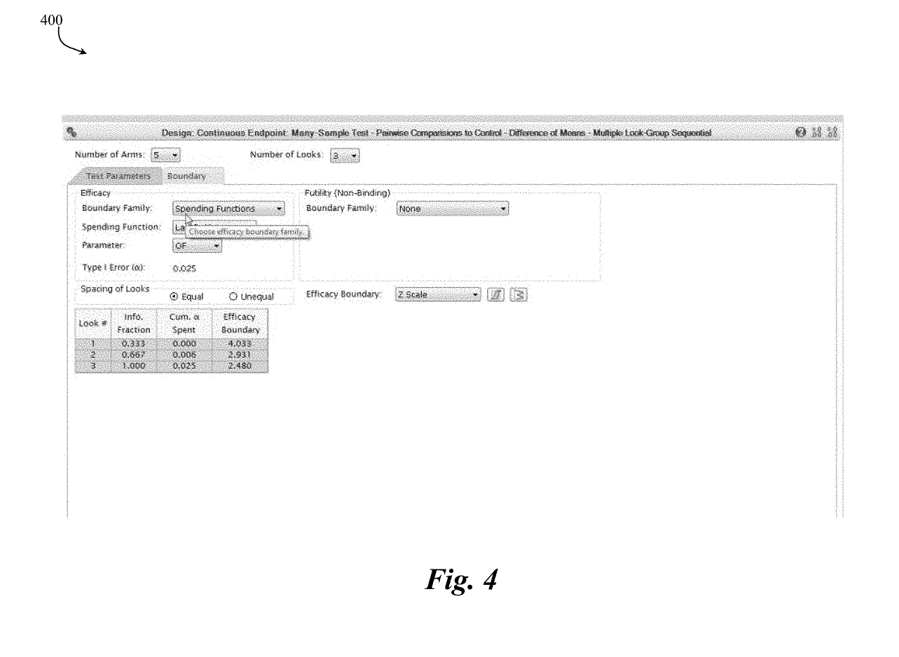

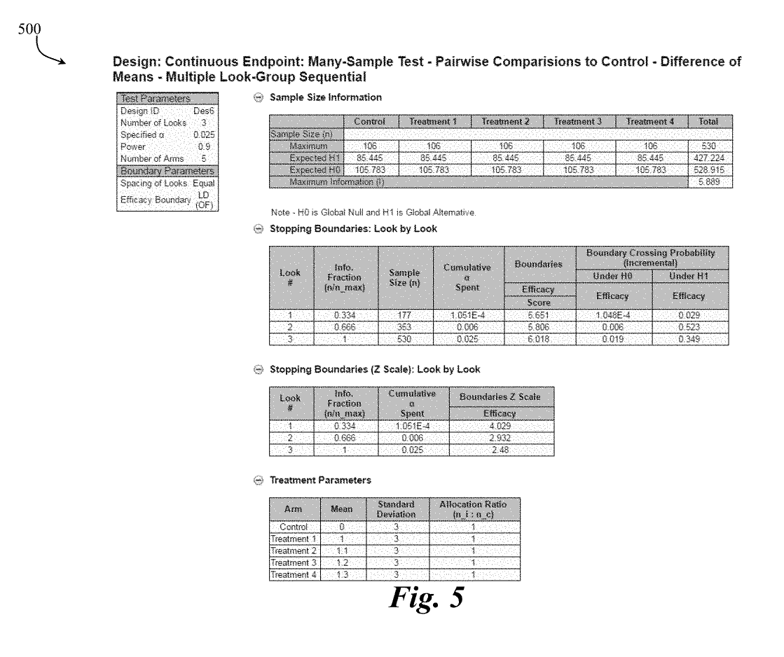

FIG. 1B depicts a flow chart implementing six steps implementing the process 100 in accordance with aspects of the present invention, as discussed with respect to FIG. 1A. At step 108, the system receives the experiment design parameters, as discussed with respect to FIGS. 4 and 5. For example, a user enters the experiment design parameters (e.g., a number of arms and stages) into a user interface to be processed by the unique combination of algorithms system. At step 130, the system breaks the design parameters into independent increments, as discussed in greater detail with respect to step 106 of FIG. 1A. At step 132, the system reduces the dimensionality, as discussed in greater detail with respect to step 110 of FIG. 1A. At step 134, the system transforms the integration from infinite to finite, as discussed in greater detail with respect to step 112 of FIG. 1A. At step 136, the system computes integration using Monte Carlo number theoretic approach, as discussed in greater detail with respect to step 120 of FIG. 1A. At step 138, the system simulates the experiment scenarios, as discussed in greater detail with respect to step 212 of FIG. 2. At step 140, the system evaluates the most favorable designs, as discussed in greater detail with respect to step 214 of FIG. 2. At step 142, the MAMs experiment(s) are conducted using the most favorable designs.

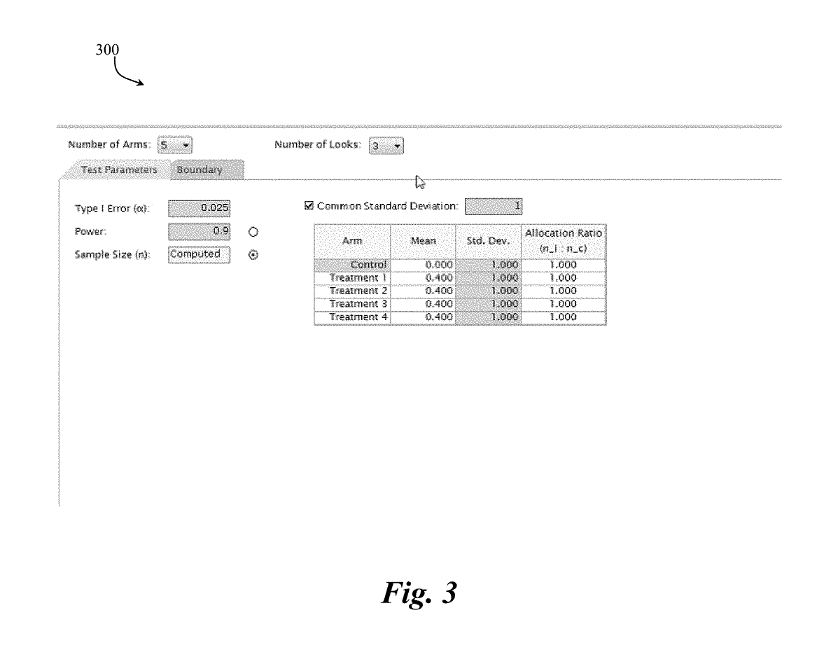

FIG. 2 depicts an exemplary flow chart for a computing device to process the steps as discussed with respect to FIGS. 1A and 1B. In particular, FIG. 2 depicts the process 200 for implementing the steps as discussed with respect to FIGS. 1A, 1B, and 3-5. At step 202, the system receives parameters to design the experiment. As would be appreciated by one skilled in the art, the parameters can include any known parameters utilized in calculating the values in accordance with the present invention. For example, the parameters can include, but are not limited to, acceptable error rates, anticipated difference between arms, estimated variance of outcomes, allocations of samples between arms, etc. At step 204, the system receives boundaries for the experiment. As would be appreciated by one skilled in the art, the boundaries can include any known boundaries utilized in calculating the values in accordance with the present invention. For example, the boundaries can include, but are not limited to, selected spending functions, input spacing of interim looks, etc. In accordance with an example embodiment of the present invention, the parameters and boundaries of steps 202 and 204 can be received through a manual input by a user into a user interface, as depicted in FIGS. 3 and 4.

At step 206, the parameters and boundaries received at steps 202 and 204 are provided as input parameters into the statistical algorithm to be processed by the system of the present invention. At step 208, the system computes the boundaries based on the input variables of step 206. Similarly, at step 210, the system computes the sample size based on the input variables of step 206. The steps 208 and 210 are the design phase of the statistical algorithm of the present invention. In particular, at step 208, the system computes the boundaries for each stage utilizing equations (1-19). At step 212, the data from the preceding steps is utilized by the system to simulate the experiment scenarios. At step 214, the results of the simulated experiment scenarios are evaluated for best experiment designs. Once the best experiment designs are identified, the system of the present invention selects the best experiment designs for presentation to a user (e.g., via a user interface). In particular, the system software compares the experiment designs prior to running an experiment, thus permitting the best or optimal design to be chosen. In other words, the computations performs in the unique combination of equations, as discussed herein, provides the various experiment designs in a computationally tractable way to be conveyed to a user in a graphical interface.

FIGS. 3-5 depict exemplary user interfaces for display on a computing device implementing the present invention. In particular, FIGS. 3-5 depict various user interface screens for entering data to be used in the processes discussed with respect to FIGS. 1A, 1B, and 2. FIG. 3 depicts a test parameters screen 300 in which a user can enter the test parameters to be utilized by the system and the statistical algorithm. For example, the test parameters can include Type I Error α, power, samples size (n), common standard deviation, a number of arms, and a number of looks. As would be appreciated by one skilled in the art, each of the test parameters can be entered using any user interface mechanism known in the art (e.g., drop box, text box, etc.).

FIG. 4 depicts a boundary screen 400 in which a user can enter the boundaries to be utilized by the system and the statistical algorithm. For example, the boundaries can include boundary family, spending function, parameter, spacing of looks, efficacy boundary, number of arms, and number of looks. As would be appreciated by one skilled in the art, each of the test parameters can be entered using any user interface mechanism known in the art (e.g., drop box, text box, etc.).

FIG. 5 depicts a result screen 500 produced by the system and the statistical algorithm.

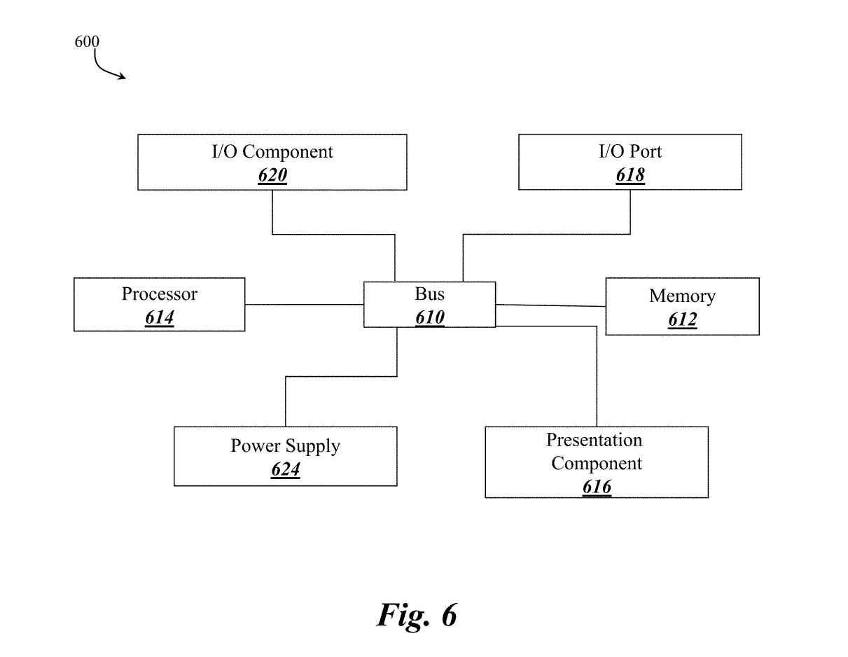

Any suitable computing device can be used to implement the methods/functionality described herein and be converted to a specialized system for performing the operations and features described herein through modification of hardware, software, and firmware, in a manner significantly more than mere execution of software on a generic computing device, as would be appreciated by those of skill in the art. One illustrative example of such a computing device 600 is depicted in FIG. 6. The computing device 600 is merely an illustrative example of a suitable computing environment and in no way limits the scope of the present invention. A “computing device,” as represented by FIG. 6, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 6 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of designing multi-arm multistage (MAMS) experiments, the method comprising:
identifying a MAMS experiment problem;
breaking the MAMS experiment problem into a plurality of independent increments, each independent increment comprising a multi-stage problem;
reducing a dimensionality of the plurality of independent increments using a Score Statistic;
transforming the MAMS experiment problem into a finite integration; and
computing the integration using a quasi-Monte Carlo approach.

2. The method of claim 1, wherein the method complexity increases linearly based on number of stages and number of arms, as represented by the equation J×D, where J is number of stages and D is number of arms.

3. The method of claim 1, wherein the method complexity does not increase exponentially based on number of stages and number of arms.

4. The method of claim 1, wherein breaking the MAMS experiment problem into a plurality of independent increments comprises collecting data from the MAMS experiment, and calculating a cumulative score test statistic.

5. The method of claim 1, wherein reducing a dimensionality of the plurality of independent increments using a Score Statistic comprises converting the MAMS experiment problem into J consecutive stages.

6. The method of claim 1, wherein transforming the MAMS experiment problem into a finite integration comprises transforming a correlated normal integration into an integration of independent normal variables, transforming a lower integration limits from negative infinity to zero.

7. The method of claim 1, wherein computing the integration using a quasi-Monte Carlo approach comprises generating lattice points of a lattice, shifting the lattice by a random vector amount, converting to points between zero and one, and evaluating integrand and taking an average.

8. The method of claim 1, wherein the computations necessary to create a multi-arm multistage (MAMS) experiments are made iteratively to create many designs for a range of design assumptions, such ranges and parameters being input by a user of the system either from an electronic file or manually.

9. A system for multistage multi-arm (MAMS) experiments, the system comprising:
a parameter intake, configured to prompt and receive input for experiment design parameters;
a boundaries intake, configured to prompt and receive input for experiment design boundaries;
a simulator engine, configured to receive input parameters comprised of the experiment design parameters and the experiment design boundaries, and further configured to execute simulations determining boundaries efficacy based on the input parameters;
wherein the simulator engine utilizes a method comprising:
breaking a MAMS experiment problem into a plurality of independent increments, each independent increment comprising a three-stage problem;
reducing a dimensionality of the plurality of independent increments using a Score Statistic;
transforming the MAMS experiment problem into a finite integration; and
using a quasi-Monte Carlo number theoretic approach, computing the integration.

10. The system of claim 9, wherein the experiment design parameters comprise acceptable error rates, anticipated difference between arms, estimated variance of outcome, and allocation of sample between arms.

11. The system of claim 9, wherein the experiment design boundaries comprise select spending function and input spacing of interim looks.

12. The system of claim 11, wherein any number of experimental simulations, resulting from applying the mathematics described for claim 1 iteratively, may be compared in a graphic and/or tabular form within the system and favorable designs selected and retained.

13. A method of designing a multi-arm multistage (MAMS) experiment, the method comprising:
receiving input parameters comprising experiment design parameters and experiment design boundaries;
computing boundaries;
computing sample size;
executing a first simulation of the MAMS experiment to determine a first set of boundaries efficacy;
modifying one or more input parameters;
executing a second simulation of the MAMS experiment to determine a second set of boundaries efficacy; and
comparing the first set of boundaries efficacy with the second set of boundaries efficacy to identify a preferred boundaries efficacy.

14. A method for constructing a D-arm J-stage design for N number of stages, the method comprising:
computing a first boundary for a first stage N using a distribution of D-score statistics at the first stage;
incrementing a stage value N by one and advancing to a next stage;
updating the distribution of D-score statistics at a second stage for a second stage N+1;
computing a second boundary for the second stage N+1 using the distribution of D-score statistics at a second stage;
incrementing a stage value N+1 by one and advancing to a next stage; and
continuing incrementing stage values, advancing stages, and updating the distribution of D-score statistics to correspond to the stage values until a stage value is equal to J number of stages.
